(19) United States
(12) Patent Application Publication
(10) Pub. No.: US 2026/0105176 A1
(43) Pub. Date: Apr. 16, 2026

(54) SYSTEM AND METHOD FOR SHARING SECURED TOKEN CLASSIFIED WORDS IDENTIFIED WITHIN AN AUDIO DATA STREAM ACROSS SOFTWARE APPLICATIONS ON AN INFORMATION HANDLING SYSTEM

(71) Applicant: Dell Products LP, Round Rock, TX (US)

(72) Inventors: Nicholas D. Grobelny, Evergreen, CO (US); Jacob Mink, Cedar Park, TX (US)

(73) Assignee: Dell Products LP, Round Rock, TX (US)

(21) Appl. No.: 18/911,613

(22) Filed: Oct. 10, 2024

(51) Int. Cl. G06F 21/62; G06F 21/60

(52) U.S. Cl. CPC G06F 21/6227; G06F 21/602

(57) ABSTRACT

An information handling system may execute an audio service and filter encryption driver to identify a first grouped set of one or more words and a second grouped set of one or more words within received user query input data, match the first grouped set of words to a first designated privilege type category, match the second grouped set of words to a second designated privilege type category and encrypt the first grouped set of one or more words using a first decryption key in a first encrypted buffer range and selectively send the first decryption key to a first artificial intelligence (AI) productivity tool software process and encrypt the second grouped set of one or more words using a second decryption key in a second encrypted buffer range and selectively send the second decryption key to a second AI productivity tool software process being executed on the information handling system.

### FIELD OF THE DISCLOSURE

The present disclosure generally relates to securing a user query input data stream from access by an unauthorized processes executed on the information handling system. The present disclosure more specifically securing token-classified words within an audio data stream of a user query input from access by an unauthorized artificial intelligence (AI) productivity tool or other software processes executed on the information handling system until and unless an decryption key used to access the token-classified words within the audio, video, text or image of the user query input data stream stored is provided to the AI productivity tool or other software process.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, communication capabilities. The information handling system may be used to execute computer-readable program code instructions of one or more workspace productivity applications or other application such as for teleconferencing, word processing, sales systems, business software, gaming applications, or the like. Further, the information handling system may include an on the box (OTB) artificial intelligence (AI) productivity tool software module employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions of an audio service and filter encryption driver to receive user query input, execute a speech-to-text inference on the user query input, and classify the detected text with one or more privacy setting category for designated types of privileged data, and provide individualized decryption keys to be used, individually, by a plurality of AI productivity tool or other software processes having authorization for designated types of privileged data according to an embodiment of the present disclosure;

FIG. 2 is a block diagram illustrating a process flow of a hardware processor executing computer readable code instructions of an audio service and filter encryption driver to secure user query input data for across multi-application sharing of the user query input data based on authorizations to access designated types of privileged data according to an embodiment of the present disclosure; and

FIG. 3 is a flow diagram showing a method of executing computer readable code instructions of an audio service and filter encryption driver to secure user query input data for multi-application sharing of portions the user query input data based on authorizations to access designated types of privileged data according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tool software applications to optimize user productivity and performance of the information handling systems. Examples of such artificial intelligence methodologies includes chatbots to simulate conversations between the information handling system and the user. In an example embodiment of the present disclosure, an AI productivity tool software application may be used to trigger changes in firmware or hardware (e.g., changing display or power settings), software, or processes of one or more AI productivity tool-enablable software applications (e.g., send an e-mail or text message, schedule a meeting, generate a responsive message).

Various machine learning models may be used to support such functionality, including automatic speech recognition (ASR) models, text embedding models, text-to-speech machine learning (ML) model algorithms, and similarity search models that may work in combination with one another to identify a responsive capability intent action that may be taken by an AI productivity tool-enablable software applications as requested within a received user query input according to embodiments herein. For example, an existing AI productivity tool software application and an operatively-coupled to an AI productivity tool subagent may be capable of determining a user’s intent from a user query input (e.g., a query intent value) for correlation to a capability intent action that the user is requesting to be performed within the user query input, and matching that determined query intent with a capability intent known to be achievable. The capabilities and their capability intent values are based on published or established capabilities for a particular of one or more AI productivity tool-enablable software applications executing at the information handling system and may include firmware drivers for various types of hardware. In some examples, once the AI productivity tool-enablable software application capable of performing the user-requested capability intent action within the user query input is identified, the AI productivity tool subagent may identify an application programming interface (API) call that, when executed, may cause the AI productivity tool-enablable software application associated with the identified capability to perform that capability.

As users interact with the chatbot features associated with the AI productivity tool software module, audio data captured by a microphone is moved between plural software processes of the AI productivity tool software module but may be vulnerable to unauthorized access by unauthorized processes to gain access to the audio data. Further, different processes (e.g., applications of .exe files being executed by a hardware processor) may be provided with different privileges related to use, processing, and storage of their respective sets of data. In a particular example, audio data is sensitive to attack due to its applications in text-to-speech and deep fake technologies where a third-party could generate speaker embeddings and create realistic fake speech of a user based on cadence, tonality, unique spectral content, grammatical choices, vocabulary patterns of the user found in the audio data. Moreover, the audio data may even contain private personal information in need of protection, such as passwords or other identification data. Thus, embodiments of the present disclosure utilize encryption and designation of types of privileged data within portions of the audio data of a received user query input to protect and sequester portions of the same. Thus, a privileged AI productivity tool or other software process performs central processing on some portion of audio data received at the microphone for which it has designated privileges, that application respects the user data security preferences for itself and those designated privileges for other software application processes with implementation of embodiments of the present disclosure. Protection of the audio data by execution of computer readable code instructions of the audio service and filter encryption driver in embodiments herein prevents such a third-party unprivileged processes from gaining access to particular portions or all portions of the audio data or processed audio data that could be used in nefarious ways. Further, the audio service and filter encryption driver allows for user query input data to be shared with various AI productivity tool or other software processes authorized with full privileges to execute with some or all portions of the user query input data for which each have designated privileges, but not on portions for the particular various AI productivity tool or other software processes do not have designated privileges, thereby further sequestering the received user query input data into limited-access portions.

The present specification describes an information handling system that includes a hardware processor, a memory device, and a power management unit (PMU) to provide power to the hardware processor and memory. The information handling system, in an embodiment, may execute computer-readable program code of an audio service and filter encryption driver to receive recorded user query input data from a peripheral device, such as a microphone or video camera, and execute a speech-to-text machine learning (ML) model algorithm to convert speech within the user query input data into text, where the text includes one or more words. In embodiments herein, the user query input data may include a stream of a plurality of words which may be identified in text by the speech-to-text ML model algorithm. In an embodiment, the hardware processor may further execute the computer-readable code instructions of the audio service and filter encryption driver to execute a token classification ML model algorithm that identifies the one or more words within the text of the user query input and matches individual words of the one or more words to designated privilege type of data having a privacy setting category. The hardware processor executing code instructions of the audio service and filter encryption driver may include execution of a token classification ML model algorithm to group sets of one or more words with lexical or semantic matching to the designated type of privilege data from among a plurality of available designated privileges types of data known in a database at the audio service and filter encryption driver. The identified token classification value, as a metadata value for example, may be generated for a designated privilege type of data with a corresponding privacy setting category for a grouped set of words. In embodiments herein, the designated privilege type of data for a grouped set of words may also be referred to herein as a designated privilege type category for that grouped set of one or more words identified within the received user query input data.

The hardware processor may also execute the computer-readable code instructions of the audio service and filter encryption driver to encrypt a matched first grouped set of one or more words using a first decryption key on behalf of a first AI productivity tool or other first software process being executed on the information handling system based on the designated privilege type of data and associated privacy setting category of the matched first grouped set of one or more words. Execution of the computer-readable code instructions of the audio service and filter encryption driver encrypts a matched second grouped set of one or more words from the user query input data using a second decryption key on behalf of a second AI productivity tool or other second software process being executed on the information handling system based on a second designated privilege type of data and associated privacy setting category of the matched second grouped set of one or more words.

In an embodiment, the information handling system may further include a kernel system memory that includes an encrypted buffer to store the audio data and associated text data with the one or more words and prevents access to any software process executing on the information handling system to the associated text with one or more words of a given designated privilege type of data unless that software process provides either of the first decryption key or second decryption key to the audio service and filter encryption driver that decrypts the user query input data or portions thereof to which the software process has designated privileges under the associated privacy setting category. The hardware processor may execute computer-readable program code instructions of the audio service and filter encryption driver to define cleanup information including a memory-erasure policy describing how the kernel system memory is to erase the recorded user query input data and associated text with one or more words. This allows for secure data to be deleted when no longer needed so that this data may remain secure throughout the processes described herein.

In an embodiment, the hardware processor may execute the computer-readable code instructions of the audio service and filter encryption driver to execute the token classification ML model algorithm to classify each set of one or more words within a designated privilege type of data with its associated privacy setting category. As described, the hardware processor executing code instructions of the audio service and filter encryption driver may include execution of a token classification ML model algorithm to group sets of one or more words with lexical or semantic matching to the designated type of privilege data from among a plurality of available designated privileges types of data known in a database at the audio service and filter encryption driver. The identified token classification value, as a metadata value for example, may be generated for a designated privilege type of data for a grouped set of words with a corresponding privacy setting category. As described, the designated privilege type of data for a grouped set of words may also be referred to herein as a designated privilege type category for each grouped set of one or more words identified within the received user query input data.

The privacy setting category for each designated privilege type of data is associated, specifically, with the first AI productivity tool or other first software process or the second AI productivity tool or other second software process and operates to limit the number of AI productivity tool or other software processes having access for highly limited privacy setting categories in some embodiments. In other aspects, the privacy setting category may make grouped sets of one or more words identified within the user query input data more freely available with lower limited privacy setting categories which may be more shareable among more software processes but still protected with encryption described in embodiment herein. With the token classification values assigned to each set or group of one or more words for designated privilege type of data and with various associated privacy setting categories, the audio service and filter encryption driver provide access to those token-classified sets of one or more words to the first AI productivity tool or other first software process or the second AI productivity tool or other second software process by forwarding a copy of the first decryption key to the first AI productivity tool or other first software process or a copy of the second decryption key to the second AI productivity tool or other first software process and so forth that correspond to the privacy setting category or categories available to those software processes for privileged access to designated privilege types of data.

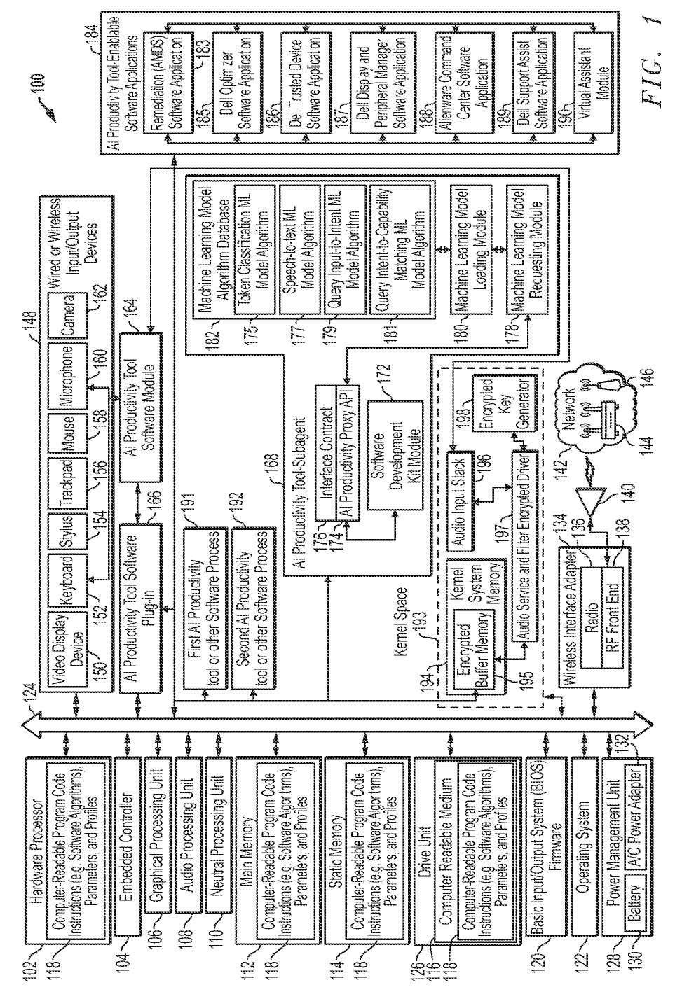

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 (e.g., central processing unit (CPU)), an embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be “hot” or quickly accessible by hardware processing resources using that main memory 112. Computer-readable program code instructions stored in static memory 114, main memory 112, or drive unit 126 may be “cold” and latency may be involved in invoking such computer-readable program code instructions to main memory 112 according to embodiments herein. Additional components of the information handling system 100 may include one or more storage devices such as static memory 114 or drive unit 126. In embodiments herein, a portion of the main memory 112 may include kernel system memory 194 that is reserved and accessible to hardware, firmware, and software executing within kernel space 193.

Kernel space 193 may include any protected area of memory in a computer system where the operating system's core functions, called a kernel, run with full access to hardware resources. By isolating kernel space from user space, the system ensures that user-level processes within the user space cannot directly interfere with or access sensitive system functions or kernel system memory 194 portions of memory 112 thereby enhancing security and stability. When a user-level application such as the first AI productivity tool or other software process 191 and second AI productivity tool or other software process 192 of an AI productivity tool software module 164 or AI productivity tool enablable software application 184 is to perform tasks like accessing memory or hardware, it must make a controlled system call to the kernel space 193, which facilitates the request. The separation between kernel space 193 and user space helps prevent malicious or poorly written applications from corrupting critical system operations or compromising data integrity such as the audio data and encrypted data described herein. Kernel space 193 acts as a safeguard, maintaining the reliability of the system while allowing user applications to function in a controlled environment.

As described herein, those software processes executing within a user space on the information handling system 100 may be prevented from accessing data on the kernel system memory 194 within one or more designated encrypted buffer memory 195 unless an decryption key has been provided to that software process within user space. In an embodiment, the data maintained on the kernel system memory 194 at one or more designated encrypted buffer memory 195 may include words identified within an audio data stream of an user query input data and may be classified using a token classification machine learning (ML) model algorithm to determine one or more designated privilege types of data associated with one or more portions (i.e., words or sets of words) within the user query input data. In an embodiment, the buffer may include any partitions or ranges of specified memory within the kernel system memory 194 that receives the encrypted user query input (e.g., text, audio, video, images) and secures that data until requested by an authorized AI productivity tool or other software process (e.g., 191, 192). The information handling system 100 may include or interface with one or more communications ports for communicating with external devices, as well as various input and output (I/O) devices 148, such as a mouse 158, a trackpad 156, a stylus 154, a keyboard 152, a video/graphics display device 150, a microphone 160, a camera 162, or any combination thereof. These one or more I/O devices 148, such as microphone 160 may be used to receive the user query input data in embodiments herein. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 118 that may operate on servers or systems, remote data centers, or on-box in individual client information handling systems according to various embodiments herein. In some embodiments, it is understood any or all portions of instructions (e.g., software algorithms), parameters, and profiles 118 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing instructions (e.g., software algorithms), parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 210, APU 208, and/or others may execute one or more bus drivers in order to transmit this data between the information handling system 100 and the input/output devices 148 described herein. In an embodiment, the information handling system 100 may be in wired or wireless communication with the I/O devices 148 such as a keyboard 152, a mouse 158, video display device 150, stylus 154, trackpad 156, microphone 160, a camera 162, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 148, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the I/O devices 148 according to the embodiments described herein. The present specification contemplates that the I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 136 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 140 or base station 142 used to operatively couple the information handling system 100 to a network 142 via a wireless interface adapter 134. In a specific embodiment, the network 142 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 134 may include one or more RF (RF) subsystems (e.g., radio 136) with transmitter/receiver circuitry, modem circuitry, one or more antenna RF (RF) front end circuits 138, one or more wireless controller circuits, amplifiers, antennas 136 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles118 may be executed by a hardware processor 102, GPU 106, EC 104 or any other hardware processing resource and may include software agents, or other aspects or components used to execute the methods and systems described herein. Various software modules comprising application computer-readable program code instructions, parameters, and profiles 118 may be coordinated by an OS 122, and/or via an application programming interface (API). An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, or GPU 106, NPU 110, APU 108 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, APU 108, NPU 110, a video/graphic display device 150, or other wired I/O devices 148 such as the mouse 158, the stylus 154, the keyboard 152, the microphone 160, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 114 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 164 and an AI productivity tool subagent 168 used to receive user query input and provide that user query input to the AI productivity tool subagent 168. In an embodiment, the execution of the computer-readable code instructions 118 of the AI productivity tool subagent 168 by the hardware processor 102 or any other hardware processing device selects among a plurality of machine learning (ML) model algorithms (e.g. a token classification ML model algorithm 175, a speech-to-text ML model algorithm 177, query input-to-intent ML model algorithm 179, and a query intent-to-capability ML model algorithm 181) maintained within a ML model algorithm database 182 for execution of user input query processing steps of operations for the AI productivity tool software module 164 and for use with execution of a plurality of AI productivity tool-enablable software applications 184 (e.g., 183, 185, 186, 187, 188, 189, 190) according to another embodiment of the present disclosure. As described herein, the computer-readable code instructions 118 of the AI productivity tool software module 164 and AI productivity tool subagent 168 may be executed by a hardware processor 102 on the information handling system 100 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The AI productivity tool module 156 may include any artificial intelligence-based productivity tool to assist in interfacing with and execution of one or more AI productivity tool-enablable software applications 184 or inputs and responses from a user of an information handling system 100. The AI productivity tool software module 164 may be loaded on-the-box by a manufacturer in software and may include chatbot features, virtual assistant features, and other artificial intelligence features that allow a user to provide input to the information handling system 100 and, with generative artificial intelligence processing of a user input query, execute one or more capabilities that include hardware operations, functions, software services, or responses using one or more AI productivity tool-enablable software applications 184. Examples of some AI productivity tool software modules 164 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 100 may include any proprietary AI productivity tool software module 164 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool software module 164 with its AI productivity tool plug-in 166 and monitor for user query input for a user at a microphone 160, keyboard 152, camera 162, or other input device for the AI productivity tool subagent 168 to engage in capability intent actions pursuant to the user query input.

The AI productivity tool software module 164, executing on the hardware processor 102 or other hardware processing resource (e.g., EC 104, GPU 106, APU 108, or NPU 110), may interface with other hardware components and with the AI productivity tool-enablable software applications 184 as well as one or more ML module algorithms 175, 177, 179, 181 via an AI productivity tool plug-in 166. The AI productivity tool plug-in 166 may be any software or firmware that allows the AI productivity tool subagent 168 to perform those actions at the information handling system 100 based on user query input (e.g., typed, spoken words, images, etc.) provided from the user. The AI productivity tool plug-in 166 may be used by the AI productivity tool software module 164 and AI productivity tool subagent 168 to interface with any number of AI productivity tool-enablable software applications 184 executing or executable on the information handling system 100 according to embodiments herein.

Again, the information handling system 100 also includes the AI productivity tool subagent 168 associated with the AI productivity tool software module 164. The AI productivity tool subagent 168 may be any software and/or firmware executable by the hardware processor 102 of the information handling system 100 to interface one or more of the plurality of the AI productivity tool-enablable software applications 184 (such as a remediation (AMDS) software application 183, Dell ® Optimizer ® software application 185, Dell ® Trusted Device ® software application 186, Dell ® Display and Peripheral Manager ® software application 187, Alienware® Command Center ® (AWCC) software application 188, Dell ® Support Assist ® software application 189, and a virtual assistant module 190) to provide AI enabled capabilities within those AI productivity tool-enablable software applications 184 (e.g., 183, 185, 186, 187, 188, 189, 190) for responsive hardware, firmware, or software operations, functions, software services, or responses to user input queries. In an embodiment, the computer-readable code instructions of the software applications (e.g., AI productivity tool-enablable software applications 184 and modules described herein (e.g., 183, 185, 186, 187, 188, 189, 190) may operate wholly “on-box” within the information handling system 100 or be sub-agents on-box for interfacing with remote software systems executing at remote server locations. In an embodiment, the AI productivity tool subagent 168 may be used to direct the execution of various modules in support of the AI productivity tool-enablable software applications 164 described herein. Additionally, the AI productivity tool subagent 168 may be provided with access to the BIOS and OS of the information handling system 100 to conduct the capability intent actions pursuant to the user query input provided by the user via the AI productivity tool software module 164 or with an interface of one of the AI productivity tool-enablable software applications 184.

In an embodiment, during operation, the hardware processor 102 or other hardware processing resource (e.g., EC 104, GPU 106, CPU, APU 108, or NPU 110) executes computer-readable program code instructions of an audio service and filter encryption driver 197. The audio service and filter encryption driver 197 may be any computer-readable program code instructions that receives any user query input data, in an audio or video format, from an I/O device 148 such as from microphone 160 as monitored with the AI productivity tool software application 164 and encrypts that data. During operation, for example, a user may engage with a microphone 160, a camera 162, or other audio input/output device 148 in order to provide a user query input. For purposes of explanation, an example user query input may include the phrase or phrases “I have to remember to log into my bank account today, hmm . . . What was my password? . . . Is it jellybean?” This audio data received at the microphone 160, for example, and the AI productivity tool software application 164 contains secure data such as an indication of a password as well as a potential password. The audio data also includes subject matter that may not be secure but nonetheless may be used by other specific AI productivity tool-enable software applications 184 in response to the user’s query provided. For example, the audio data may include scheduling data that could be used by a calendaring software application (e.g., acting as the AI productivity tool-enable software application 184) to set a reminder for the user to “remember to log into [the user’s] bank account today.” Although this portion of audio data within the user query input may not necessarily need to be marked as secure data, it may still be restricted data that is to be used by only specific AI productivity tool-enable software applications 184 such as the calendaring software application that have privacy setting category authority for designated privilege type of data found in relevant words or sets of words in the user query input data.

It is appreciated that other data may be received from other peripheral devices and may be used as user query input as described herein. For example, the keyboard 144 may be used to receive text input from the user and pass that text to the audio service and filter encryption driver 197 or other filter driver executing via a hardware processor such that this text data cannot be accessible to any unauthorized process being executed on the information handling system or externally. As described herein, this text data may also be encrypted and made accessible to only those unprivileged software process that have an decryption key to access. Additionally, any unprivileged software process that is provided with this decryption key may access this text data and identify a capability associated with one or more AI productivity tool-enablable software applications to perform a capability intent action. It is also appreciated that other types of user query input may also be provided such as images and computer files. Again, this data may be provided at the AI productivity tool software module and the first unprivileged software process 191 may direct that this data be encrypted and made accessible to only those unprivileged software process that have a decryption key to access. Thus, although the present specification describes the incoming user query input as audio and/or video data, the present specification also contemplates that text and image input may be used as user query input as well.

In an embodiment, this recorded user query input data may be passed from the microphone 160 to the audio service and filter encryption driver 197 via the AI productivity tool software application 164 and an audio input stack 196 temporary buffer memory. The audio input stack 196 may include any layered architecture of software, firmware, and/or hardware that work together with a buffer memory to capture, process, transmit and render audio input and may include the buffer memory to temporarily store the streaming recorded user query input data prior to passing the recorded user query input data to the audio service and filter encryption driver 197. In an embodiment, the recorded user query input data may be passed to the audio service and filter encryption driver 197 prior to the AI productivity tool subagent 168 with the audio service and filter encryption driver 197 directing the processing of the recorded user query input data prior to the AI productivity tool subagent 168 invoking any ML module algorithms 175, 177, 179, 181 for identifying a responsive capability and/or any AI productivity tool-enable software applications 184 to execute a responsive capability intent action.

The audio service and filter encryption driver 197 may be any computer-readable program code instructions that execute via a hardware processor such as 102 to secure data within the recorded user query input data so that no other AI productivity tool or other software executing within user space can gain access to that user query input data unless an decryption key is provided. It is appreciated that any other type of encryption driver may be used to encrypt any type of streaming user query input such as text, images, and video to secure that data on the kernel system memory 194 as described herein. Thus, in some embodiments, the information handling system may include the audio service and filter encryption driver 197 described herein along with a video service and filter encryption driver (not shown) to receive and encrypt video user query input data, a text service and filter encryption driver to receive and encrypt text user query input data, and an image service and filter encryption driver to receive and encrypt image user query input as described herein. The present specification contemplates, therefore, that these other types of user query input can be received and processed as well according to the methods described herein.

Additionally, in an embodiment, the decryption keys described herein may be any authorizing data that allows access to the encrypted user query input stored on the kernel system memory 194. In an embodiment, the decryption keys may operate as operators that allow for decryption of specified ranges of memory of the kernel system memory 194 where specific encrypted user query input has been stored. Therefore, in some embodiments, each of the described decryption keys may provide access to one or more AI productivity tool or other software process with this access to certain specified user query input data portions, some of which may be overlapping with each other. This allows some data to be masked from, for example, the first AI productivity tool or other software process 191, some data to be masked from the second AI productivity tool or other software process 192, and some data to be made accessible to neither or both of the first AI productivity tool or other software process 191 and second AI productivity tool or other software process 192.

In an embodiment, execution of the computer-readable code instructions of the audio service and filter encryption driver 197 causes the audio service and filter encryption driver 197 to engage with the AI productivity tool subagent 168 to, via a machine learning model request module 178 and machine learning module loading module 180, execute a speech-to-text ML model algorithm 177 (e.g., an automatic speech recognition machine learning module) with the recorded user query input data used as input to the speech-to-text ML model algorithm 177. The execution of the speech-to-text ML model algorithm 177 by the AI productivity tool subagent 168 converts the recorded user query input data into text such that individual words within the recorded user query input data can be defined. As such, the user query input at the microphone 160 by the user can be converted into text format via execution of computer readable code instructions of the speech-to-text ML model algorithm 177 by a hardware processor 102, or audio hardware controller in some embodiments, in order to identify one or more words present within the recorded user query input data. This process is directed by the audio service and filter encryption driver 197 with the audio service and filter encryption driver 197 preventing access to the input (e.g., the recorded user query input data) and output (e.g., the one or more identified words) to any other AI productivity tool or other software.

Additionally, execution of the computer-readable code instructions of the audio service and filter encryption driver 197 by a hardware processor (e.g., 102, 104, 106, 108, 110) causes the audio service and filter encryption driver 197 to receive the output from the invocation of the speech-to-text ML model algorithm 177 and request that a token classification ML model algorithm 175 be executed to identify the one or more words within the identified within text from the recorded user query input data and match the some portion of those one or more words to designated privilege types of data each associated with a privacy setting category. In an embodiment, a token classification value, such as a metadata value, may be defined as a designated privilege type of data classification for one or more words within the text of the recorded user query input data that is grouped or otherwise assigned to the designated privilege type of data having a privacy setting category. The hardware processor executing 102 code instructions of the audio service and filter encryption driver 197 may include execution of a token classification ML model algorithm 175 to group sets of one or more words with lexical or semantic matching to the designated type of privilege data from among a plurality of available designated privileges types of data known in a database at the audio service and filter encryption driver. The identified token classification value may be generated for a designated privilege type of data for a grouped set of words with a corresponding privacy setting category that may be used to correspond with access authorization of one or more AI productivity tool or other software processes to determine authorization to access encrypted grouped sets of one or more words from the user query input. In various embodiments herein, designated privilege type of data for a grouped set of words may also be referred to herein as a designated privilege type category for that grouped set of one or more words identified within the received user query input data.

In an embodiment, any of a plurality of privacy setting categories may be available for each identified designated privilege type of data of the grouped sets of one or more words in the text and sets a privacy setting. This privacy setting may be included in metadata of the token classification value for grouped one or more words that may be matched to define which of any of a plurality of AI productivity tool-enablable software applications 184 or other software processes of the AI productivity tool software module 164 can access that data for those grouped subsets of one or more words in the user query input data having a designated privilege type of data.

The AI productivity tool-enablable software applications 184 may include, for purposes of explanation, a first AI productivity tool or other software process 191 and a second AI productivity tool or other software process 192. It is appreciated that the AI productivity tool-enable software applications 184 such as 183, 185, 186, 187, 188, 189, and 190 may be given differing levels of authority to gain access to these grouped sets of one or more words identified based on token classification values of the grouped sets of one or more words from the recorded user query input data by the speech-to-text ML model algorithm 177 and associated with a designated privilege type of data.

In the present specification and in the appended claims, the term “unprivileged” with reference to an AI productivity tool or other software process is meant to be understood as any process that is executed within Ring 3 of a hierarchical protection domain. For example, a kernel space 193 may execute computer-readable program code and provide memory space at Ring 0 within the hierarchical protection domain. Accordingly, a Ring 3 executed process relies on the OS 122 to give a small portions of memory within the RAM, for example, that can be accessed by the Ring 3 executing process. However, this portion of memory is not necessarily protected from access by other Ring 3 executing processes (e.g., computer-readable program code and processes). Thus, Ring 0 within the kernel space 193 may be privileged memory space and computer-readable program code instructions that has access to all physical memory while a Ring 3 computer-readable program code instructions and processes do not have access to all memory except that portion of memory allocated for operation of the Ring 3 computer-readable program code instructions and processes. It is appreciated, therefore, that the audio/video input stack 196, the audio service and filter encryption driver 197, the kernel system memory 194, and the encrypted buffer memory 195 may be within the kernel space 193 so that the audio/video data received at the microphone 160 and other peripheral devices is held and stored within a portion of memory that cannot be accessed by non-kernel space devices, firmware, and software such as the first unprivileged AI productivity tool or software process 191 and second unprivileged AI productivity tool or software process 192 among other computer-readable program code instructions and processes given Ring 3 or lower privileges. It is appreciated that more or less of the hardware devices, modules, software applications, and processes shown in FIG. 1 may be included within the kernel space 193 so as to protect the audio data streaming to the audio service and filter encryption driver 197.

In the example presented herein, a privacy setting may be assigned to the token classified words “remember to log into my” within the identified group of one or more words that defines that only a first AI productivity tool or other software process 191 such as a calendaring software application can gain access to that designated privilege type of data (e.g., calendaring type of classification) within the recorded user query input data. Still further, another privacy setting may be assigned to the token classification value for words “bank account” within another grouped classification of the one or more words that defines that a plurality of AI productivity tool software applications 164 can gain access to that data such as both the first AI productivity tool or other software process 191 (e.g., the calendaring software application) and a second AI productivity tool or other software process 192 such as a password vault agent may access this type of designated privilege type of data. This allows some words within the one or more identified grouped sets of one or more words in the recorded user query input data to be associated with a designated privilege type of data that multiple AI productivity tool-enablable software applications 184, 191, 192 can gain access to. In still further example embodiments, yet another privacy setting may be assigned to the words “password” and “jellybean” in yet another token classification value for a designated privilege type of data that indicates that the password vault agent acting as a particular, second AI productivity tool or other software process 192 has exclusive access to those token-classified words based on the limited privacy setting category for the token classification value of designated privilege type of data for this grouped set of one or more words identified within the recorded user query input data by the speech-to-text ML model algorithm 177.

Execution of the computer-readable code instructions of the audio service and filter encryption driver 197 further causes the audio service and filter encryption driver 197 to encrypt a first set of matched words having a first designated privilege type of data using a first decryption key on behalf of the first AI productivity tool or other software process 191 being executed on the information handling system based on associated privacy setting category for that token classification value of the designated privilege type of data for the first set of matched words. In an embodiment, this encryption process may be completed as the recorded user query input data is streaming such that the encryption process is done in real times as the recorded user query input data is passed from the microphone 160, through the AI productivity tool software application 164 and audio input stack 196, to the audio service and filter encryption driver 197. As described herein, this encryption may include the encryption of the words “remember to log into my” having a first designated privilege type of data that is completed using a first decryption key and the audio service and filter encryption driver 197. The audio service and filter encryption driver 197 may transmit that first decryption key to the matching first AI productivity tool or other software process 191 which is, in this example embodiment, is a calendaring software application having authorization to access this first designated privilege type of data.

If the associated privacy setting allows for other software processes that may be active with the AI productivity tool software module 164, the first or a second decryption key may also be sent to other software processes as well as to the first AI productivity tool or other software process 191. For example, when the associated privacy setting has a low privacy requirement, a second AI productivity tool or other software process 192 may also receive the decryption key to access “bank account” words in the user query input data. In an example embodiment, the encryption process may include the encryption of a second set of matched words having a second designated privilege type of data with a second decryption key on behalf of a second AI productivity tool or other software process 192 being executed on the information handling system based on associated privacy setting category of the second set of matched words having the second designated privilege type of data. In the context of the present example, this second set of matched words may include the words “bank account.” As such the decryption key used to encrypt these words may be passed onto one or more AI productivity tool or other software processes, which may include the calendaring software application acting as the first AI productivity tool or other software process 191 and the password vault agent acting as the second AI productivity tool or other software process 192, such that both may access the grouped one or more words “bank account” having a designated privilege type of data.

In another embodiment, it is appreciated that other decryption keys may be used to encrypt other words within a set of grouped one or more identified words having another designated privilege type of data within the recorded user query input data by the speech-to-text ML model algorithm 177. For example, the words “password” and “jellybean” may be encrypted using a third decryption key by the audio service and filter encryption driver 197 as a result of those words being associated with another designated privilege type of data with a higher level of privacy setting category and associated privacy setting classification. This grouped set of one or more words in the user query input with this designated privilege type of data may only be accessible by a password vault software process which may be one of limited AI productivity tool or other software processes having a privacy setting category authorization to this designated privilege type of data. Thus, only AI productivity tool or other software processes with this high level of privacy setting category or a particular token classification value for a designated privilege type of data may be sent this third decryption key for access.

In an embodiment, the hardware processor may execute the computer-readable code instructions of the audio service and filter encryption driver 197 to encrypt the first set of match words to a first designated privilege type of data and second set of matched words to a second designated privilege type of data with separate decryption keys as the recorded user query input data is streaming from the peripheral device using a homomorphic encryption. Homomorphic encryption allows for mathematical operations or processing on encrypted data with decrypting it first or accessing the secret decryption key in some embodiments to further protect privacy of the grouped sets of one or more words in the user query input data for privacy of the user in embodiments herein. Examples may include the use of Microsoft ® SEAL, HElib, and other full homomorphic encryption (FHE) types including those of a Homomorphic Encryption Standard in some embodiments. Partially homomorphic cryptosystems may also be used in some embodiments. In the context of the present specification, by using a homomorphic encryption process, the audio service and filter encryption driver 197 may encrypt the one or more identified words grouped with a designated privilege type of data once they are received as output from the speech-to-text ML model algorithm 177. In some embodiments, the homomorphic encryption process may also include the ability of the first AI productivity tool or other software process 191, the second AI productivity tool or other software process 192, the audio service and filter encryption driver 197 and/or the AI productivity tool subagent 168 to use that encrypted data without having to first decrypt that data using the first decryption key, the second decryption key, or any other decryption key provided to an AI productivity tool or other software process 191, 192, 184 by the audio service and filter encryption driver 197 for processing while protecting privacy.

In an embodiment, after the audio service and filter encryption driver 197 has encrypted the grouped sets of one or more words in each respective designated privilege type of data, the audio service and filter encryption driver 197 may store the encrypted grouped sets of one or more words on respective portions of an encrypted buffer memory 195 or separate encrypted buffers of the kernel system memory 194. In an example embodiment, each of the grouped sets of one or more words having a designated privilege type of data may be saved to the encrypted buffer memory 195 at different locations on the kernel system memory 194 and the audio service and filter encryption driver 197 may identify a memory handle associated with each of these memory locations to pass on to the respective first AI productivity tool or other software process 191 and/or second AI productivity tool or other software process 192 having privacy type authority to access those grouped sets of one or more words along with the respective decryption keys so that the first AI productivity tool or other software process 191 and second AI productivity tool or other software process 192 can access the respective data that each are allowed to access.

In an embodiment, the audio service and filter encryption driver 197 may further specify cleanup data that defines how and if the saved one or more words on the encrypted buffer memory 195 is to be deleted. In an example embodiment, the audio service and filter encryption driver 197 may provide or point to a memory-erasure algorithm that defines if, when, and how any data in the encrypted buffer memory 195 is deleted, including the one or more words and associated privacy setting classification, maintained on the encrypted buffer memory 195 of the kernel system memory 194. In an embodiment, the hardware processor may conduct the deletion of the data in the encrypted buffer memory 195 pursuant to the memory-erasure algorithm. This memory-erasure algorithm may define if and when this data is to be deleted after a first or subsequent access by the first AI productivity tool or other software process 191 and/or second AI productivity tool or other software process 192, whether the permission to delete the audio and/or video data is to be provided solely by the audio service and filter encryption driver 197, and if and what time limit is provided until the data is to be deleted. It is appreciated that any type of condition or algorithm may be provided that dictates if, by what, and when the stored data of grouped sets of words having a designated privilege type of data is to be deleted from the encrypted buffer memory 195 and the present specification contemplates these other conditions and algorithms.

In an embodiment, each of the first AI productivity tool or other software process 191 and second AI productivity tool or other software process 192 may access the encrypted words of grouped sets with one or more designated privilege types of data on the portions of encrypted buffer memory 195. Accessing this data on the encrypted buffer memory 195 may allow each of the first AI productivity tool or other software process 191 and second AI productivity tool or other software process 192 to engage in intent identification based on the recorded user query input data. Continuing with the example above, the calendaring software application may access its associated word or words having a designated privilege type of data for calendaring data or other privilege type stored on the encrypted buffer memory 195 and engage with the AI productivity tool subagent 168 to identify a capability of the calendaring software application for example. The calendaring software application acting as the first AI productivity tool or other software process 191, in an example embodiment, may access the word or words saved on the encrypted buffer memory 195 and provide that data to the AI productivity tool subagent 168 for identifying a capability of the calendaring software application that can fulfill the user query as recorded in the recorded user query input data.

For example, the execution of the computer-readable code instructions of the AI productivity tool subagent 168 may call a software development kit (SDK) module 172. The SDK module 172 may include any computer-readable program code instructions that is executed by the hardware processor 102 or other hardware processing resource to request that a ML model algorithm 175, 177, 179, 181 be invoked to support the one or more AI productivity tool or other software processes to identify, in an embodiment, a capability intent action based on received user query inputs from a user and execute such responsive capability intent actions. In an example, the ML model algorithms 175, 177, 179, 181 stored on a machine learning model algorithm database 182 may include a query input-to-intent ML model algorithm may receive the word or words grouped for one or more designated privilege types of data of the user query input accessible by the calendaring software application and generates a vectorized multimodal query intent value for the multimodal user query input using an embedding algorithm of the query input-to-intent ML model algorithm 179. In another example embodiment, the ML model algorithms may also include a query intent-to-capability matching ML model algorithm 181 that receives the vectorized query intent value or vectorized multimodal query intent value as input, matches the vectorized query intent value or vectorized multimodal query intent value to a vectorized capability intent value associated with the AI productivity tool-enablable software application 184 via a similarity correlation algorithm, and identifies a capability that can serve as the capability intent action responsive to a user query input. In the context of the calendaring software application, this identified capability may include inserting a reminder notification on a digital calendar that reminds the user, per the recorded user query input data, to “remember to log into [the user’s] bank account.”

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

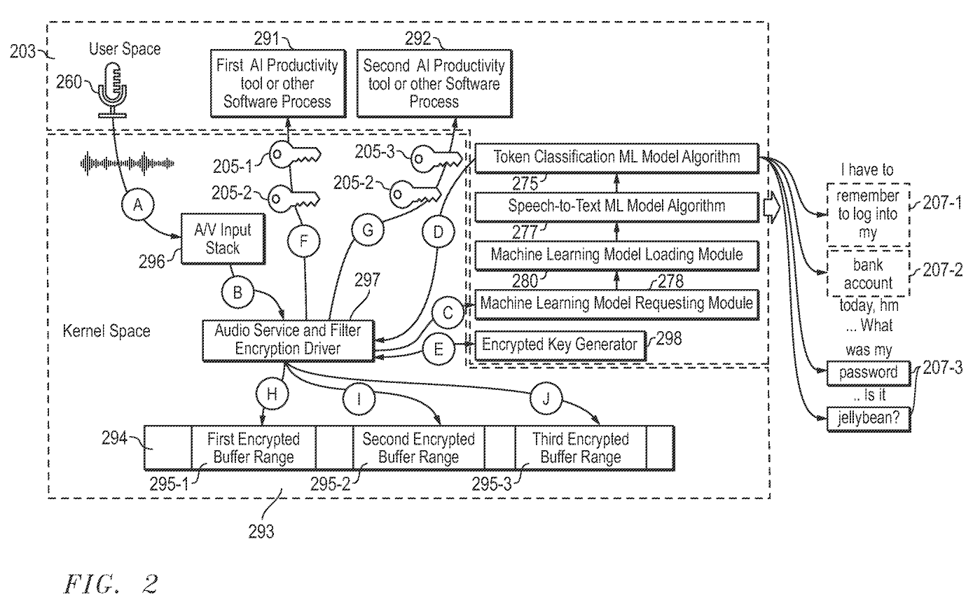

FIG. 2 is a block diagram illustrating a process flow and block diagram of execution of computer readable code instructions for an audio service and filter encryption driver to secure user query input data for multi-application sharing of the user query input data according to an embodiment of the present disclosure. FIG. 2 shows some of the steps within the process flow diagram being carried out within a user space 203 while other processes are carried out within a kernel space 293. It is appreciated that those processes executed by the audio service and filter encryption driver 297 include security procedures that protect the access to the audio input and data of user query input among a plurality AI productivity tool and other software processes are described herein.

As described above, kernel space 293 may include any protected area of memory in a computer system where the operating system's core functions, called a kernel, run with full access to hardware resources. By isolating kernel space from user space, the system ensures that user-level processes within the user space cannot directly interfere with or access sensitive system functions or kernel system memory 294 serving as buffers or portions of memory (e.g., contiguous buffer memory) thereby enhancing security and stability. The kernel system memory 294 may serve as a buffer memory (e.g., a contiguous buffer memory) for the encrypted user query input in an embodiment. When a user-level application such as the first AI productivity tool or other software process 291 and second AI productivity tool or other software process 292 of an AI productivity tool software module or AI productivity tool enablable software application is to perform tasks like accessing memory or hardware, it must make a controlled system call to the kernel space 293, which facilitates the request. The separation between kernel space 293 and user space helps prevent malicious or poorly written applications from corrupting critical system operations or compromising data integrity such as the audio data and encrypted data described herein. Kernel space 293 acts as a safeguard, maintaining the reliability of the system while allowing user applications to function in a controlled environment.

In an embodiment, the hardware processor executing computer readable code instructions of the audio service and filter encryption driver 297 may direct that audio from a microphone 260 may be routed to the audio service and filter encryption driver 297 so that it can be encrypted and set aside as privileged data with a token classification value for one or more designated privilege types of data for use by the first AI productivity tool or other software process 291, the second AI productivity tool or other software process 292, and/or any other AI productivity tool or other software process described herein. Token classification values may be generated for the designated privilege types of data from grouped sets of one or more words from the user query input data. In embodiments herein, the designated privilege types of data from grouped sets of one or more words may also be referred to as designated privilege types. The audio service and filter encryption driver 297 may also send a requesting signal to the AI productivity tool software module (e.g., 164, FIG. 1) to have the audio data detected at the microphone 260 as a user query input transmitted to the audio service and filter encryption driver 297 via an A/V input stack 296 buffer memory. The AI productivity tool software module may detect that raw user query input data is received at line “A” and temporarily stored at an A/V input stack 296 buffer memory. This signal to transmit this audio data defining the recorded user query input data is shown at line “B” where the user query input data is transmitted, via the A/V input stack 296, to the audio service and filter encryption driver 297 using a secure communication such that no other AI productivity tool or other software process cannot access that audio data of the recorded user query input data without an decryption key provided by the audio service and filter encryption driver 297.

In an embodiment, the audio input stack 296 may transmit the audio data defining the recorded user query input data to the audio service and filter encryption driver 297 at line “B.” The execution of the computer-readable code instructions of the audio service and filter encryption driver 297 then proceeds to conduct a plurality of operations on the recorded user query input data such as converting the audio in the recorded user query input data into text, identifying one or more words within the text as having one or more designated privilege type of data with associated privacy setting categories, and encrypting the one or more words using one or more decryption keys based on the one or more privacy settings for those designated privilege type of data associated with grouped sets of the one or more words determined from the user query input.

In an initial process at line “C,” the audio service and filter encryption driver 297 may cause computer-readable program code instructions of a machine learning model requesting module 278 and machine learning model loading module 280 to request and load a speech-to-text ML model algorithm 277 in one embodiment. In another embodiment, a speech-to-text ML module algorithm 277 may execute locally with the audio service and filter encryption driver 297. The invocation of the speech-to-text ML model algorithm 277 may cause the recorded user query input data to be converted to text such that individual words spoken by the user into the microphone 260 may be identified and classified for designated privilege types of data.

Each of the one or more words identified via execution of the speech-to-text ML model algorithm 277 may be grouped into token classification values for groups of words in designated privilege types of data that can be used by the audio service and filter encryption driver 297 to encrypt these groups of words based on identified token classification values for each designated privilege type of data. The hardware processor executing code instructions of the audio service and filter encryption driver 297 may include execution of a token classification ML model algorithm 275 to group sets of one or more words within the user query input data with lexical or semantic matching to the designated type of privilege data from among a plurality of available designated privileges types of data known in a database at the audio service and filter encryption driver 297. These known, available designated privilege types of data may include keywords or semantic intent values for matching the grouped set of one or more words with a token classification value. The identified token classification value may be determined for a designated privilege type of data or designated privilege type category for a grouped set of words with a corresponding privacy setting category for that grouped set of one or more words identified within the received user query input data. With token classification values for a particular one or more designated privilege types of data for different grouped sets of one or more words, these classified grouped sets of one or more words may be selectively shared with one or more of the first AI productivity tool or other software process 291, second AI productivity tool or other software process 292, and/or any other AI productivity tool or other software process as part of the process steps of the AI productivity tool software module executing to identify or execute one or more responsive capabilities to the user query input.

In an example embodiment, the detected text from the recorded user query input data may include the phrase or phrases “I have to remember to log into my bank account today, hmm . . . What was my password? . . . Is it jellybean?” This audio data received at the microphone 260 and the AI productivity tool software application may contain secure data such as an indication of a password as well as the potential password. The audio data may also include subject matter that may not be secure but nonetheless may be used or specifically directed to other specific AI productivity tool-enablable software applications in response to the user’s query input. As such, the audio service and filter encryption driver 297 may also cause that a token classification ML module algorithm 275 to be invoked by the machine learning model requesting module 278 and loaded by the machine learning model loading module 280 in order to classify each of these words or groups of words identified within the recorded user query input data into one or more available designated privilege types of data. In the example presented herein, a first grouped set of one or more words 207-1 with a first privacy setting may be assigned to the token classification value for a designated privilege type of data for the grouped words “remember to log into my” that defines that only the first AI productivity tool or other software process 291 may utilize this grouped set of one or more words in the user query input. For example, the first AI productivity tool or other software process may be a calendaring software application that can gain access to that data for the “remember to …” grouped set of one or more words within the recorded user query input data.

Still further, a second grouped set of one or more words 207-2 with a second privacy setting may be assigned to the token-classified words “bank account” within a designated privilege type of data that defines that a plurality of AI productivity tool software applications 291, 292 can gain access to that grouped set of one or more words 207-2 such as both the first AI productivity tool or other software process 291 (e.g., the calendaring software application) and a second AI productivity tool or other software process 292 such as a password vault agent. The grouped set of one or more words 207-2 with the designated privilege type of data for “bank account” may be identifying data used to determine what should be remembered in the calendaring application as well as identifying data indicating what type of password data may be saved in a password data vault for example. This allows some words within the one or more identified words in the recorded user query input data to be associated with multiple AI productivity tool-enablable software applications (e.g., 291, 292) that can gain access to this data.

In still further example embodiments, yet another grouped set of one or more words 207-3 with a third privacy setting for a third designated privilege type of data may be assigned to the words “password” and “jellybean” that may have a very restricted privacy setting category with limited availability among AI productivity tool or other software processes. The third designated privilege type of data and associated token classification value indicates that only software processes such as the password vault agent acting as the second AI productivity tool or other software process 292 have authorization to access to those token classified words with such a designated privilege type of data from within the one or more words identified within the recorded user query input data by the speech-to-text ML model algorithm 277. The privacy setting category may be set by a user or information technology decision maker (ITDM) to include more or fewer AI productivity tool or other software processes depending on security policies employed for the information handling system. Further, access to particular grouped sets of one or more words from the user query input data may be topically limited as described herein such that relevant grouped sets of words are matched by designated privilege type category with AI productivity tool or other software processes that have a topically relevant need for such data. Thus, other AI productivity tool or other software processes with a high level of access to a highly limited privacy setting category, may not have access to passwords in a user query input if such information is not relevant to operations of that software process in example embodiments.

At line “D,” the process may continue with the audio service and filter encryption driver 297 receiving the identified grouped sets of one or more words and their associated token classification values for designated privilege types of data with associated privacy setting categories. It is appreciated that in an embodiment, execution of code instructions of the audio service and filter encryption driver 297 may interface with an AI productivity tool subagent (e.g., 168, FIG. 1) as described in connection with FIG. 1. In an alternative embodiment, the audio service and filter encryption driver 297 may execute a machine learning model requesting module 278 and machine learning model loading module 280 dedicated for the operation of the audio service and filter encryption driver 297 in order to invoke the speech-to-text ML model algorithm 277 and token classification ML module algorithm 275 as described herein. The execution of code instructions of the speech-to-text ML model algorithm 277 may execute as above to determine text data from the speech user query input data received from microphone 260. With the text of the user query input, the ML model requesting module 176 may use keyword matching or semantic matching with embedded text values of words or phrases to determine with execution of a token classification ML model algorithm 275 recognized grouped sets of one or more words. The hardware processor executing computer readable code instructions of the token classification ML model algorithm 275 may use lexical or semantic matching of grouped sets of one or more words with designated privilege types having token classification values of the data in accordance with use of the data by particular types of AI productivity tool or other software processes or by privacy setting levels for the data in such designated privilege type categories.

In an embodiment, once the audio service and filter encryption driver 297 has received the identified grouped sets of one or more words and their associated designated privilege types of data or designated privilege type categories with associated privacy setting categories, the audio service and filter encryption driver 297 may access an decryption key generator 298 at line “E.” The execution of the computer-readable code instructions of the decryption key generator 298 creates an decryption key for each identified grouped sets of one or more words having designated privilege type categories and their associated privacy setting categories. Thus, in an example embodiment, a first decryption key may be generated by the decryption key generator 298 and used by the audio service and filter encryption driver 297 to encrypt the first grouped set of words 207-1 “remember to log into my” in the present example with a first designated privilege type category. This associates the first grouped set of one or more words 207-1 of a user query input with a first designated privilege type categories and first privacy setting with the specific first decryption key. This process may be conducted for each identified grouped set of one or more words 207-1, 207-2, 207-3 in the user query input with its own respective designated privilege type categories and each grouped set of one or more words 207-1, 207-2, 207-3 being encrypted by the audio service and filter encryption driver 297 using a different generated decryption key 205-1, 205-2, and 205-3.

In an embodiment, the process may continue with the audio service and filter encryption driver 297 delivering the individual decryption keys 205-1, 205-2, or 205-3 to their respective AI productivity tool or other software processes 191 or 192 having authorization to use or access the particular designated privilege type categories particular to each grouped set of one or more words 207-1, 207-2, 207-3 at lines “F” and “G.” For example, at line “F,” a first decryption key 205-1 is sent to the first AI productivity tool or other software process 291 allowing access to the encrypted data for the first grouped set of one or more words 207-1 “remember to log into my” stored by the audio service and filter encryption driver 297 on, for example, a first encrypted buffer range 295-1 on the buffer memory 294 at line “H.” Additionally, a second decryption key 205-2, at lines “F” and “G” may be sent to both the first AI productivity tool or other software process 291 and the second AI productivity tool or other software process 292 as a result of the grouped set of one or more words 207-2 “bank account” available to be used by both the first AI productivity tool or other software process 291 (e.g., a calendaring software application to calendar an identification of an event) and the second AI productivity tool or other software process 292 (e.g., the password vault agent to identify a secured possible password type). Concurrently, the audio service and filter encryption driver 297 may store the encrypted data for associated with the second grouped set of one or more words 207-2 of a second designated privilege type with second privacy setting on a second encrypted buffer range 295-2 at line “I.” Still further, a third decryption key 205-3, at line “G,” may be sent to the second AI productivity tool or other software process 292 with the associated encrypted data for the third grouped set of words 207-3 “password” and “jellybean” being stored on a third encrypted buffer range 295-3 at line “J.”

It is appreciated that, although FIG. 2 shows the buffer memory 294 divided into a first encrypted buffer range 295-1, a second encrypted buffer range 295-2, and a third encrypted buffer range 295-3, the buffer memory 294 may not be divided in this way. In an embodiment, the buffer memory 294 may be a specified contiguous portion of memory space that includes ranges of encrypted memory for use in the present system and method described herein. Therefore, in some embodiments, each of the described decryption keys may provide access to one or more AI productivity tool or other software process with this access to certain specified user query input overlapping with each other in this contiguous portion of buffer memory. This allows some data to be masked from, for example, the first AI productivity tool or other software process 291, some data to be masked from the second AI productivity tool or other software process 292, and some data to be made accessible to neither or both of the first AI productivity tool or other software process 291 and second AI productivity tool or other software process 292.

With the first decryption key 205-1, second decryption key 205-2, and third decryption key 205-3 being delivered, the respective first AI productivity tool or other software process 291 and second AI productivity tool or other software process 292 may gain access to the appropriate encrypted buffer ranges 295-1, 295-2, 295-3 to conduct operations of the AI productivity tool software module to receive a user query input and to determine a responsive capability intent action using the first AI productivity tool or other software process 291, the second AI productivity tool or other software process 292, or other AI productivity tool software processes according to embodiments herein. In the context of the present example embodiment, the calendaring software application acting as the first AI productivity tool or other software process 291 may set a reminder on a digital calendar reminding the user to log into the user’s bank account. Similarly, the password vault agent acting as the second AI productivity tool or other software process 292 may place the password “jellybean” and associated with a user’s “bank account” within a secure data storage associated the password vault agent and associate that password with a user’s bank account, such as one previously accessed by the user or defined by the user.

It is appreciated that each of the first AI productivity tool or other software process 291 and second AI productivity tool or other software process 292 cannot access data on any of the encrypted buffer ranges 295-1, 295-2, 295-3 to which an decryption key 205-1, 205-2, 205-3 has not been provided to the first AI productivity tool or other software process 291 or second AI productivity tool or other software process 292. In the context of the present example embodiment, therefore, the calendaring software application cannot gain access to the data stored on the third encrypted buffer range 295-3 because the calendaring software application acting as the first AI productivity tool or other software process 291 did not receive the third decryption key 205-3 that is used to gain access to that data. For example, the identification of a password being in the user query input and a potential password “jellybean” encrypted and stored in the third encrypted buffer range 295-1 in the buffer memory 294 may not be accessed without decryption key 205-3. Thus, the first AI productivity tool or other first software process 291, such as a calendaring software process, may not access the third encrypted buffer range 295-3 having stored encrypted data for the third grouped set of one or more words 207-3 for “password” and “jellybean.”

As described herein, the present systems and methods prevents access to secure data originating from recorded user query input data to those AI productivity tool or other software processes that should not have access to that data. A user may grant access to some of these AI productivity tool or other software processes by altering the settings. However, without the user’s knowledge sensitive data may be sequestered to only those AI productivity tool or other software process that should be allowed access to that data. This audio data associated with the operation of the microphone 260, for example, may be sensitive to attack to glean private data such as password data or other personal private data as well as due to the user query input data being applied in text-to-speech and deep fake technologies which may be used for generating unauthorized speaker embeddings and creating realistic speech based on grammatical and vocabulary patterns of the user. The present system and method prevents such nefarious uses of this audio data by third-parties thereby protecting the user’s information and securing data therein.

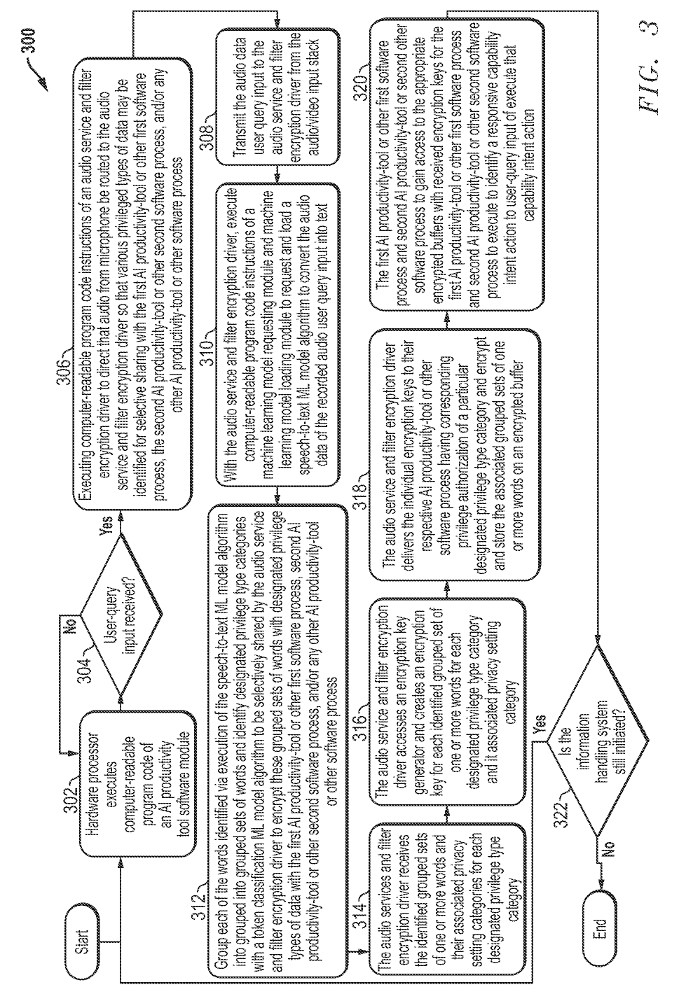

FIG. 3 is a flow diagram showing a method of securing user query input data for selective sharing among plural AI productivity tool or other software processes according to an embodiment of the present disclosure. The method 300 described in connection with FIG. 3 may be operated on an information handling system such as an information handling system (e.g., 100, 200) described in connection with FIGS. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The method 300 may include, at block 302, the hardware processor or other hardware processing device of the information handling system executing computer-readable program code instructions of an AI productivity tool software module including access to one or more AI productivity tool-enablable software applications executing on the information handling system. In an embodiment, AI productivity tool software module may be any application that can receive audio input from a microphone of the information handling system that serves as recorded user query input data from a user. In an embodiment, the AI productivity tool module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for recorded user query input data in the form of audio at the microphone for the intent identification software application of an AI productivity tool subagent to engage in capability intent actions pursuant to the recorded user query input data as described herein.

Therefore, at block 304, the method 300 also includes determining whether any user query input in the form of recorded user query input data has been received at the AI productivity tool software module. Where, at block 304, no user query input is received, the method 300 returns to block 302 with the AI productivity tool software module continuing to monitor for this input. Where, at block 304, the AI productivity tool software module does detect and receive recorded user query input data from the microphone, the method 300 continues to block 306 with execution of computer readable code instructions of an audio service and filter encryption driver directing that audio from a microphone may be routed to the audio service and filter encryption driver so that portions of it can be identified as grouped sets of one or more words set aside as privileged data within a designated privilege type category for selective sharing and use by the first AI productivity tool or other software process, the second AI productivity tool or other software process, and/or any other AI productivity tool or other software process described herein. This may include the audio service and filter encryption driver sending a requesting signal to the AI productivity took software module (e.g., 164, FIG. 1) to have the audio data from the microphone be transmitted to the audio service and filter encryption driver via an audio/video (A/V) input stack buffer. This signal to transmit this audio data defining the recorded user query input data may be transmitted, via the A/V input stack, using a secure communication such that no other AI productivity tool or other software process cannot access that audio data of the recorded user query input data without an decryption key provided by the audio service and filter encryption driver.

In an embodiment, the audio/video input stack buffer may transmit the audio data defining the recorded user query input data to the audio service and filter encryption driver at block 308. As described herein, the execution of the computer-readable code instructions of the audio service and filter encryption driver then proceeds to conduct a plurality of operations on the recorded user query input data such as converting the audio in the recorded user query input data into text, identifying grouped sets of one or more words within the text as having one or more designated privilege type categories with associated privacy setting categories, and encrypting the grouped sets of one or more words using one or more decryption keys based on the one or more designated privilege type categories with privacy settings associated with the grouped sets of one or more words.

At block 310, the audio service and filter encryption driver may cause computer-readable program code instructions of a machine learning model requesting module and machine learning model loading module to request and load a speech-to-text ML model algorithm. The invocation of the speech-to-text ML model algorithm may cause the recorded user query input data to be converted to text such that individual words spoken by the user into the microphone. Each of the one or more words identified via execution of the speech-to-text ML model algorithm may be grouped, at block 312, into token classification value identified groups of words for selective sharing by the audio service and filter encryption driver to encrypt these groups of words for use by the first AI productivity tool or other software process 291, second AI productivity tool or other software process 292, and/or any other AI productivity tool or other software process. In an example embodiment, the detected text from the recorded user query input data may include the phrase or phrases “I have to remember to log into my bank account today, hmm . . . What was my password? . . . Is it jellybean?” This audio data received at the microphone and the AI productivity tool software application may contain secure data such as an indication of a password as well as a potential password. The audio data may also include subject matter that may not be secure but nonetheless may be used by other specific AI productivity tool-enablable software applications in response to the user’s query provided. Some portions of the user query input data may be topically limited to particular AI productivity tool or other software processes or may be more generally applicable to plural AI productivity tool or other software processes, but nonetheless protected by encryption from outside access by unauthorized software processes in other various embodiments herein.

As such, the audio service and filter encryption driver may also cause that a token classification ML module algorithm to be invoked by the machine learning model requesting module and loaded by the machine learning model loading module in order to classify each of these words or groups of one or more words identified within the recorded user query input data. The hardware processor executing code instructions of the audio service and filter encryption driver may include execution of a token classification ML model algorithm to group sets of one or more words with lexical or semantic matching to the designated type of privilege data from among a plurality of available designated privileges types of data known in a database at the audio service and filter encryption driver. The identified token classification value for a designated privilege type of data or designated privilege type category for a grouped set of words also may include a corresponding privacy setting category for that grouped set of one or more words identified within the received user query input data.

In the example presented herein, a token classification value for a first designated privilege type category with a first privacy setting may be assigned to the token words “remember to log into my” within the identified one or more words that defines that only the first AI productivity tool or other software process such as a calendaring software application can gain access to that data within the recorded user query input data as it has topical relevance to calendaring. Still further, a token classification value for a second designated privilege type category with a second privacy setting may be assigned to the token-classified words “bank account” within the grouped set of one or more words that defines that a plurality of AI productivity tool software applications can gain access to that data such as both the first AI productivity tool or other software process (e.g., the calendaring software application) and a second AI productivity tool or other software process (e.g., a password vault agent) as that data has a lower level of limitation for privacy setting and has a broader topical relevance to both the first and second AI productivity tool or other software processes. This allows some words within the one or more identified words in the recorded user query input data to be associated with multiple AI productivity tool-enablable software applications that can gain access to this data. In still further example embodiments, yet another token classification value for a third designated privilege type category with a third privacy setting may be assigned to the words “password” and “jellybean” that indicates that the password vault agent acting as the second AI productivity tool or other software process has exclusive access to those token-classified words within the one or more words identified within the recorded user query input data by the speech-to-text ML model algorithm. The privacy setting may be highly limited access restricted as well as topically limited to an AI productivity tool or other software process designated as requiring access to a particular password (or generally to passwords) in some embodiments.

At block 314, the method 300 includes the audio service and filter encryption driver receiving and identifying a plurality of grouped sets of one or more words and their designated privilege types of data. Execution of computer readable code instructions of the token classification ML module as described above yields a token classification for portions of the user query input data in the identified plurality of grouped sets of one or more words as described herein via lexical or semantic matching with a database of available designated privilege type categories having associated privacy settings. Upon identification of each of the plurality of grouped sets of one or more words, each with a designated privilege type category and their associated privacy settings, the audio service and filter encryption driver may establish encryption for selective sharing of the grouped sets of one or more words from portions of the user query input data with a plurality of AI productivity tool or other software processes of software applications on the information handling system. It is appreciated that in an embodiment, the audio service and filter encryption driver may interface with an AI productivity tool subagent (e.g., 168, FIG. 1) as described in connection with FIG. 1. In an alternative embodiment, the audio service and filter encryption driver may execute a machine learning model requesting module and machine learning model loading module dedicated for the operation of the audio service and filter encryption driver in order to invoke the speech-to-text ML model algorithm and token classification ML module algorithm as described herein.

In an embodiment, once the audio service and filter encryption driver has received and identified grouped sets of one or more words each with a designated privilege type category and their associated privacy setting categories, the audio service and filter encryption driver may access an decryption key generator at block 316. The execution of the computer-readable code instructions of the decryption key generator creates an decryption key for each identified grouped set of one or more words having a designated privilege type category and their associated privacy setting category.

Thus, in an example embodiment, a first decryption key may be generated by the decryption key generator and used by the audio service and filter encryption driver to encrypt a grouped set of one or more words, such as the grouped set of words 207-1 “remember to log into my” of FIG. 2 above, having a first designated privilege type category in the present example. This associates the first designated privilege type category and a first privacy setting with the specific first decryption key for a particular AI productivity tool or other software processes, such as the first decryption key 205-1 for the first AI productivity tool or other software process 291 in the embodiment of FIG. 2 above. This process may be conducted for each grouped set of one or more words from portions of the user query input and identified designated privilege type category and privacy setting with each being encrypted by the audio service and filter encryption driver using a different generated decryption key. For example, the second grouped set of words 207-2 “bank account” of the embodiment of FIG. 2 above may be associated with a second designated privilege type category and privacy setting that is shared with plural first and second AI productivity tool and other software processes 291 and 292 such that decryption key 205-2 is shared with both. In yet another example, the third grouped set of words 207-3 “password” and “jellybean” of the embodiment of FIG. 2 above may be associated with a third designated privilege type category and privacy setting that is shared only with the second AI productivity tool and other software process 292 based on privacy setting and topical relevance such that decryption key 205-3 is shared only with the second AI productivity tool or other software process 292, such as a password data vault agent.

In an embodiment, the process may continue at block 318 with the audio service and filter encryption driver delivering the individual decryption keys to their respective AI productivity tool or other software process designated to have authorized access to a particular designated privilege type category topically or to an associated privacy setting. For example, first decryption key is sent to the first AI productivity tool or other software process allowing access to the grouped set of one or more words from the user query input data stored by the audio service and filter encryption driver on, for example, a first encrypted buffer range on the kernel system memory. A first token classification value and memory location handle may be sent to the first AI productivity tool or other software process with the first decryption key to match token classification value at the first AI productivity tool or other software process indicating authorization for access and so the first AI productivity tool or other software process may locate the first encrypted buffer range in kernel memory in some embodiments. Concurrently, the audio service and filter encryption driver may encrypt and store the encrypted data for the first grouped set of one or more words, for example 207-1 “remember to log into my” from FIG. 2 above, associated with the first designated privilege type category and a first privacy setting on a first encrypted buffer range in kernel memory. The first AI productivity tool or other software process, such as 291 from FIG. 2, may have access to the grouped set of one or more words 207-1 “remember to log into my” that may be topically relevant to its operation, such as for a calendaring software application that has capabilities as an AI productivity tool-enablable software application (e.g., 184 from FIG. 1) on the information handling system.

Additionally, a second decryption key may be sent to both the first AI productivity tool or other software process and second AI productivity tool or other software process as a result of the grouped set of one or more words, such as 207-2 “bank account” in FIG. 2 above, being available to be used by both the first AI productivity tool or other software process 291 (e.g., a calendaring software application to identify what to “remember” to do) and the second AI productivity tool or other software process 292 (e.g., the password vault agent to identify the type of “password” to be securely stored and otherwise restricted from access) as AI productivity tool-enablable software applications (e.g., 184 from FIG. 1). A second token classification value for the designated privilege type category for “bank account” grouped set of one or more words and a memory location handle may be sent to the first AI productivity tool or other software process and the second AI productivity tool or other software process with the second decryption key to match token classification values and so the first AI productivity tool or other software process and the second AI productivity tool or other software process to determine access authorization and to locate the second encrypted buffer range in kernel memory in some embodiments. Concurrently, the audio service and filter encryption driver may encrypt and store with the second decryption key the encrypted data for the second grouped set of one or more words, e.g. 207-2, associated with the second designated privilege type category and a second privacy setting on a second encrypted buffer range.

Still further, a third decryption key may be sent to the second AI productivity tool or other software process based on a third designated privilege type category and third privacy setting level for the third grouped set of one or more words from the user query input data that is authorized to have topical access and meets a third privacy setting level (e.g., highly restricted) for the third grouped set of one or more words. A third token classification value and memory location handle may be sent to the second AI productivity tool or other software process to match token classification to determine access authorization and so the second AI productivity tool or other software process may locate the third encrypted buffer range in kernel memory in some embodiments. In the example embodiment from FIG. 2 above, the third decryption key may be sent to only the second AI productivity tool or other software process as a result of the grouped set of one or more words, such as 207-3 “password” and jellybean” in FIG. 2 above, being at a highly restricted privacy level and only available to be used by the second AI productivity tool or other software process 292 (e.g., the password vault agent to securely store a possible password identified as “jellybean”) that operates as an AI productivity tool-enablable software applications (e.g., 184 from FIG. 1) on the information handling system for responsive capability actions. Concurrently, the audio service and filter encryption driver may encrypt and store the encrypted data with the third decryption key for the third grouped set of one or more words, e.g. 207-3, associated with the third designated privilege type category and a third privacy setting on a third encrypted buffer range.

In an embodiment, the audio service and filter encryption driver may further specify cleanup data that defines how and if the saved one or more words on the encrypted buffer range is to be deleted. In an example embodiment, the audio service and filter encryption driver may provide or point to a memory-erasure algorithm that defines if, when, and how any data in each of the encrypted buffer ranges are deleted, including the grouped sets of one or more words having a designated privilege type category and associated privacy setting classification, maintained on those encrypted buffer ranges of the kernel system memory. In an embodiment, the hardware processor may conduct the deletion of the data in the encrypted buffer ranges pursuant to the memory-erasure algorithm. This memory-erasure algorithm may define if and when this data is to be deleted after a first or subsequent access by the first AI productivity tool or other software process and/or second AI productivity tool or other software process, whether the permission to delete the audio and/or video data is to be provided solely by the audio service and filter encryption driver, and if and what time limit is provided until the data is to be deleted. It is appreciated that any type of condition or algorithm may be provided that dictates if, by what, and when the stored data is to be deleted from the encrypted buffer range and the present specification contemplates these other conditions and algorithms.

Proceeding to block 320, with the first decryption key, second decryption key, and third decryption key being delivered, the respective first AI productivity tool or other first software process and second AI productivity tool or other second software process may gain access to the appropriate encrypted buffer ranges to identify a user query intent and lexically or semantically match it to a capability to determine a responsive capability intent action to a user query input using operations steps involving the first AI productivity tool or other first software process, second AI productivity tool or other second software process, and so forth to execute an AI productivity tool software module or any responsive capabilities of AI productivity tool enablable software applications on an information handling system. In the context of the present example embodiment, the calendaring software application acting as the first AI productivity tool or other software process of an AI productivity tool enablable software applications having a capability intent action may set a reminder on a digital calendar reminding the user to log into the user’s bank account. Similarly, the password vault agent acting as the second AI productivity tool or other software process for an AI productivity tool enablable software application may execute a capability intent action to place the password “jellybean” within a secure data storage associated with the password vault agent and associate that password with a bank account or even a known bank account previously accessed by the user or defined by the user.

It is appreciated that each of the first AI productivity tool or other first software process and second AI productivity tool or other second software process cannot access data on any of the encrypted buffer ranges to which an decryption key has not been provided to the first AI productivity tool or other first software process or second AI productivity tool or other second software process. In the context of the present example embodiment, therefore, the calendaring software application cannot gain access to the data stored on the third encrypted buffer range because the calendaring software application acting as the first AI productivity tool or other first software process did not receive the third decryption key that is used to gain access to that data.

As described herein, the present systems and methods prevents access to secure data originating from recorded user query input data to those AI productivity tool or other software processes that should not have access to that data. A user may adjust authorized grants of access to some of these AI productivity tool or other software processes by altering the settings. However, without the user’s knowledge sensitive data may be sequestered to only those AI productivity tool or other software process that should be allowed access to that data. This audio data associated with the operation of the microphone, for example, may be sensitive to attack due to its application in text-to-speech and captured audio data of user query inputs may contain sensitive personal privacy data, such as password information in an example embodiment above. Further, the capture of audio data may be subject to misuse with deep fake technologies such as generating speaker embeddings and creating realistic speech based on grammatical and vocabulary patterns of the user. The present system and method prevents such nefarious uses of this audio data by third-parties thereby protecting the user’s information and secure data by sequestering and encrypting portions of the user query input data with different decryption keys granting access authorizations based on designated privilege type category shared among plural AI productivity or other software processes according to embodiments herein.

At block 322, the method 300 includes determining if the information handling system is still initiated. Where the information handling system is still initiated, the method 300 proceeds to block 302 as described herein. Where the information handling system is no longer initiated, the method 300 may end here.

The blocks of the flow diagrams of FIGS. 2 and 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor, a memory device, and a power management unit to provide power to the hardware processor and memory device;
an input/output microphone device to receive recorded user query input data;
the hardware processor to execute computer-readable program code of an audio service and filter encryption driver to convert speech within the user query input data into text with a plurality of words;
the hardware processor to execute a token classification ML model algorithm that identifies a first grouped set of one or more words within the user query input data, matches the first grouped set of the one or more words to a designated privilege type category, and assigns a first token classification value to the first grouped set of one or more words; and
the hardware processor to execute the computer-readable code instructions of the audio service and filter encryption driver to encrypt and store the first grouped set of one or more words using a first decryption key for the first designated privilege type category in a first encrypted buffer range in a kernel system memory;
the hardware processor transmitting the first decryption key to a first artificial intelligence (AI) productivity tool or other first software process being executed on the information handling system based on it having access authorization to the first designated privilege type category for the first grouped set of one or more words of the user query input data; and
the hardware processor to execute the computer-readable code instructions of the audio service and filter encryption driver to encrypt and store a second grouped set of one or more words using a second decryption key for a second designated privilege type category in a second encrypted buffer range and send the second decryption key to a second AI productivity tool or other second software process being executed on the information handling system.

2. The information handling system of claim 1 further comprising:
the kernel system memory that includes the first encrypted buffer range to store the audio and associated text with the first grouped set of one or more words in encrypted format encrypted by the first decryption key and prevents access by any AI productivity tool or other software process executing on the information handling system to the first grouped set of one or more words that does not provide the first decryption key to the audio service and filter encryption driver.

3. The information handling system of claim 1 further comprising:
the kernel system memory that includes the second encrypted buffer range to store the audio and associated text with the second grouped set of one or more words in encrypted format encrypted by the second decryption key and prevents access by any AI productivity tool or other software process executing on the information handling system to the second grouped set of one or more words that does not provide the second decryption key to the audio service and filter encryption driver.

4. The information handling system of claim 1 further comprising:
the hardware processor to execute computer-readable program code instructions of the audio service and filter encryption driver to define cleanup information including a memory-erasure policy describing how the kernel system memory is to erase the first grouped set of one or more words from the user query input data in the first encrypted buffer range and to erase the second grouped set of one or more words from the user query input data in the second encrypted buffer range.

5. The information handling system of claim 1 further comprising:
the hardware processor to execute the computer-readable code instructions of the audio service and filter encryption driver to encrypt the first grouped set of one or more words and the second grouped set of one or more words from the recorded user query input data as it is streaming from the input/output microphone peripheral device via an audio/video input stack buffer range.

6. The information handling system of claim 1 further comprising:
the hardware processor to execute the computer-readable code instructions of the audio service and filter encryption driver to send the first token classification value and a first memory location handle to the first AI productivity tool or other software process with the first decryption key for the first token classification to match the access authorization to the first designated privilege type category for the first AI productivity tool or other first software process and the memory location handle to indicate a location of the first encrypted buffer range in kernel system memory to the first AI productivity tool or other first software process.

7. The information handling system of claim 1 further comprising:
the hardware processor to execute the computer-readable code instructions of the audio service and filter encryption driver to send a first memory handle with the first decryption key to the first AI productivity tool or other software process indicating a location of the first encrypted buffer range within the kernel system memory; and
the hardware processor to execute the computer-readable code instructions of the audio service and filter encryption driver to send a second memory handle with the second decryption key to the second AI productivity tool or other software process indicating a location of the second encrypted buffer range within the kernel system memory.

8. The information handling system of claim 1 wherein the encryption of the first grouped set of one or more words from the user query input data are encrypted with the first decryption key using homomorphic encryption.

9. The information handling system of claim 1, wherein the hardware processor executes the computer-readable code instructions of the audio service and filter encryption driver to send the first decryption key corresponding to the first designated privilege type category for access to the first encrypted buffer range to the second AI productivity tool or other second software process being executed on the information handling system when the second AI productivity tool or other second software process also has access authorization to the first designated privilege type category for the first grouped set of one or more words of the user query input data.

10. A method of securing user query input data for multi-application sharing of the user query input data comprising:
executing, with a hardware processor, computer-readable code instructions of an audio service and filter encryption driver to receive recorded user query input data from an audio/visual peripheral device and convert speech within the user query input data into text with a plurality of words; and
executing, via the hardware processor, the computer-readable code instructions of a token classification ML model algorithm that identifies a first grouped set of one or more words within the user query input data, matches the first grouped set of the one or more words to a first designated privilege type category, and assigns a first token classification value to the first grouped set of one or more words;
executing the computer-readable code instructions of a token classification ML model algorithm that identifies a second grouped set of one or more words within the user query input data, matches the second grouped set of the one or more words to a second designated privilege type category, and assigns a second token classification value to the second grouped set of one or more words;
executing the computer-readable code instructions of the audio service and filter encryption driver to encrypt and store the first grouped set of one or more words from the user query input data using a first decryption key for the first designated privilege type category in a first encrypted buffer range and selectively send the first decryption key to a first artificial intelligence (AI) productivity tool or other first software process being executed on the information handling system; and
executing the computer-readable code instructions of the audio service and filter encryption driver to encrypt and store the second grouped set of one or more words from the user query input data using a second decryption key for the second designated privilege type category in a second encrypted buffer range and selectively send the second decryption key to a second AI productivity tool or other second software process being executed on the information handling system.

11. The method of claim 10 further comprising:
transmitting the first decryption key to a first AI productivity tool or other first software process being executed on the information handling system based on it having access authorization to the first designated privilege type category for the first grouped set of one or more words of the user query input data; and
transmitting the second decryption key to the second AI productivity tool or other second software process being executed on the information handling system based on it having access authorization to the second designated privilege type category for the second grouped set of one or more words of the user query input data.

12. The method of claim 10 further comprising:
sending the first token classification value and a first memory location handle to the first AI productivity tool or other first software process with the first decryption key for the first token classification to match the access authorization to the first designated privilege type category for the first AI productivity tool or other first software process and the memory location handle to indicate a location of the first encrypted buffer range in kernel system memory to the first AI productivity tool or other first software process.

13. An information handling system comprising:
a hardware processor, a memory device, and a power management unit to provide power to the hardware processor and memory device;
an input/output microphone device to receive recorded user query input data;
the hardware processor to execute computer-readable program code of an audio service and filter encryption driver to convert speech within the user query input data into text with a plurality of words; and
the hardware processor to execute computer-readable program code of a token classification ML model algorithm that identifies a first grouped set of one or more words and a second grouped set of one or more words within the user query input data, and matches the first grouped set of the one or more words to a first designated privilege type category and the second grouped set of the one or more words to a second designated privilege type category; and
the hardware processor to execute the computer-readable code instructions of the audio service and filter encryption driver to encrypt and store the first grouped set of one or more words using a first decryption key for the first designated privilege type category in a first encrypted buffer range in a kernel system memory;
the hardware processor to execute the computer-readable code instructions of the audio service and filter encryption driver to encrypt and store the second grouped set of one or more words using a second decryption key for the second designated privilege type category in a second encrypted buffer range in a kernel system memory;
the hardware processor transmitting the first decryption key to a first artificial intelligence (AI) productivity tool or other first software process being executed on the information handling system based on having access authorization to the first designated privilege type category for the first grouped set of one or more words of the user query input data; and
the hardware processor transmitting the second decryption key to a second AI productivity tool or other second software process being executed on the information handling system based on having access authorization to the second designated privilege type category for the second grouped set of one or more words of the user query input data.

14. The information handling system of claim 13 further comprising:
the kernel system memory that includes the first encrypted buffer range to store the audio and associated text with the first grouped set of one or more words in encrypted format encrypted by the first decryption key and the second encrypted buffer range to store the audio and associated text with the second grouped set of one or more words in encrypted format encrypted by the second decryption key prevents access by any AI productivity tool or other software process executing on the information handling system to the first grouped set of one or more words or the second grouped set of one or more words that does not provide the first decryption key or the second decryption key to the audio service and filter encryption driver.

15. The information handling system of claim 13 further comprising:
the kernel system memory includes the first encrypted buffer range to store the first grouped set of one or more words in encrypted format encrypted by the first decryption key, and the audio service and filter encryption driver prevents access by the second AI productivity tool or other second software process that does not have the first decryption key; and
the kernel system memory includes the second encrypted buffer range to store the second grouped set of one or more words in encrypted format encrypted by the second decryption key, and the audio service and filter encryption driver prevents access by the first AI productivity tool or other first software process that does not have the second decryption key.

16. The information handling system of claim 13 further comprising:
the hardware processor to execute the computer-readable code instructions of the audio service and filter encryption driver to encrypt the first grouped set of one or more words and the second grouped set of one or more words from the recorded user query input data as it is streaming from the input/output microphone peripheral device via an audio/video input stack buffer.

17. The information handling system of claim 13 further comprising:
the hardware processor to execute the computer-readable code instructions of the audio service and filter encryption driver to send a first token classification value and a first memory location handle to the first AI productivity tool or other first software process with the first decryption key for the first token classification to match the access authorization to the first designated privilege type category for the first AI productivity tool or other first software process and the memory location handle to indicate a location of the first encrypted buffer range in kernel system memory to the first AI productivity tool or other first software process.

18. The information handling system of claim 13 further comprising:
the hardware processor to execute the computer-readable code instructions of the audio service and filter encryption driver to send a first memory handle with the first decryption key to the first AI productivity tool or other first software process indicating a location of the first encrypted buffer range within the kernel system memory; and
the hardware processor to execute the computer-readable code instructions of the audio service and filter encryption driver to send a second memory handle with the second decryption key to the second AI productivity tool or other second software process indicating a location of the second encrypted buffer range within the kernel system memory.

19. The information handling system of claim 13 wherein the encryption of the first grouped set of one or more words via the first decryption key and the encryption of the second grouped set of one or more words via the second decryption key are encrypted with homomorphic encryption.

20. The information handling system of claim 13, wherein the hardware processor executes the computer-readable code instructions of the audio service and filter encryption driver to send the first decryption key corresponding to the first designated privilege type category for access to the first encrypted buffer range to the second AI productivity tool or other second software process being executed on the information handling system when the second AI productivity tool or other second software process also has access authorization to the first designated privilege type category for the first grouped set of one or more words of the user query input data.
